(19) United States
(12) Patent Application Publication
(10) Pub. No.: US 2018/0167383 A1
(43) Pub. Date: Jun. 14, 2018

(54) INTEGRATION OF PASSWORD-LESS AUTHENTICATION SYSTEMS WITH LEGACY IDENTITY FEDERATION

(71) Applicant: QUALCOMM Incorporated, San Diego, CA (US)

(72) Inventors: Giridhar MANDYAM, San Diego, CA (US); Dallas James WIENER, San Diego, CA (US); Kenneth RUMER, San Marcos, CA (US)

(21) Appl. No.: 15/796,513

(22) Filed: Oct. 27, 2017

Related U.S. Application Data
(60) Provisional application No. 62/433,152, filed on Dec. 12, 2016.

(51) Int. Cl. H04L 29/06

(52) U.S. Cl. CPC H04L 63/0838

(57) ABSTRACT

Authentication techniques are provided that integrate platform-specific authentication and federated identity authentication. An example method for authenticating a user according to these techniques includes authenticating the user of a user device with a relying party and an authentication entity. The user device and the relying party support platform-specific authentication and the authentication entity does not support platform-specific authentication. The method further includes accessing an application or service provided by the relying party responsive to authenticating the user of the user device with both the relying party and the authentication entity.

### CROSS-REFERENCES TO RELATED APPLICATIONS

This application claims priority to U.S. Provisional Patent Application No. 62/433,152, filed Dec. 12, 2016, entitled “INTEGRATION OF PASSWORD-LESS AUTHENTICATION SYSTEMS WITH LEGACY IDENTITY FEDERATION,” the entire disclosure of which is hereby incorporated by reference for all purposes.

### BACKGROUND

Identity federation systems provide a means for third parties to leverage a single source of identity provisioning and verification. Service providers made use of Identity Providers (IDPs) in authentication of users so as to leverage a common authentication credential for each individual user. However, many computing devices, such as smartphones, tablets, and wearable computing devices, entering the market are configured to provide support for hardware-backed, platform-enabled authentication protocols, such as the authentication standards produced by the Fast Identity Online (FIDO) Alliance. Many legacy IDPs do not interoperate with FIDO or other platform-specific authentication credentials. Therefore, many application and/or service providers are unable to leverage a legacy IDP while taking advantage of the benefits of device authentication mechanisms, such as those defined by FIDO Alliance.

### SUMMARY

An example method for authenticating a user according to the disclosure includes authenticating the user of a user device with a relying party and an authentication entity, wherein the user device and the relying party support platform-specific authentication and the authentication entity does not support platform-specific authentication; and accessing an application or service provided by the relying party responsive to authenticating the user of the user device with both the relying party and the authentication entity.

Implementations of such a method can include one or more of the following features. The authentication entity is a legacy identity provider configured to provide federation authentication. Authenticating the user of the user device with a relying party and the authentication entity includes creating a platform-specific authentication credential; sending the platform-specific authentication credential to the relying party; receiving a one-time password from the relying party; sending the one-time password and federation credentials to the legacy identity provider; receiving an authentication confirmation from the legacy identity provider; providing the authentication confirmation to the relying party; and authenticating the user device with the relying party. Authenticating the user device with the relying party includes receiving an authentication challenge from the relying party; performing an authentication to generate a platform-specific authentication assertion; and providing the platform-specific authentication assertion to the relying party. The authentication entity is an authentication server, and wherein authenticating the user of the user device with a relying party and the authentication entity includes requesting, at the user device, provisioning of a platform-specific authentication credential from the relying party; and receiving a one-time password from the relying party. Providing the one-time password and federation credentials to the authentication server to establish the platform-specific authentication credential associated with the federation credentials. Receiving the platform-specific authentication credential from the authentication server.

An example user device according to the disclosure includes a transceiver, a memory, and a processor communicatively coupled to the transceiver and to the memory. The processor is configured to: authenticate a user of the user device with a relying party and an authentication entity, wherein the user device and the relying party support platform-specific authentication and the authentication entity does not support platform-specific authentication; and access an application or service provided by the relying party responsive to authenticating the user of the user device with both the relying party and the authentication entity.

Implementations of such a user device can include one or more of the following features. The authentication entity is a legacy identity provider configured to provide federation authentication. The processor being configured to authenticate the user of the user device with a relying party and the authentication entity is further configured to: create a platform-specific authentication credential; send the platform-specific authentication credential to the relying party; receive a one-time password from the relying party; send the one-time password and federation credentials to the legacy identity provider; receive an authentication confirmation from the legacy identity provider; provide the authentication confirmation to the relying party; and authenticate the user device with the relying party. The processor being configured to authenticate the user device with the relying party is further configured to: receive an authentication challenge from the relying party; perform an authentication to generate a platform-specific authentication assertion; and provide the platform-specific authentication assertion to the relying party. The authentication entity is an authentication server, and wherein the processor being configured to authenticate the user of the user device with a relying party and the authentication entity is further configured to: request, at the user device, provisioning of a platform-specific authentication credential from the relying party; and receive a one-time password from the relying party. The processor is further configured to provide the one-time password and federation credentials to the authentication server to establish the platform-specific authentication credential associated with the federation credentials. The processor is further configured to receive the platform-specific authentication credential from the authentication server.

A non-transitory, computer-readable medium, having stored thereon computer-readable instructions for authenticating a user of a user device, according to the disclosure includes instructions configured to cause a computing device to: authenticate the user of the user device with a relying party and an authentication entity, wherein the user device and the relying party support platform-specific authentication and the authentication entity does not support platform-specific authentication; and access an application or service provided by the relying party responsive to authenticating the user of the user device with both the relying party and the authentication entity.

Implementations of such a non-transitory, computer-readable medium can include one or more of the following features. The authentication entity is a legacy identity provider configured to provide federation authentication, and the instructions configured to cause the computing device to authenticate the user of the user device with a relying party and the authentication entity include instructions configured to cause the computing device to: create a platform-specific authentication credential; send the platform-specific authentication credential to the relying party; receive a one-time password from the relying party; send the one-time password and federation credentials to the legacy identity provider; receive an authentication confirmation from the legacy identity provider; provide the authentication confirmation to the relying party; and authenticate the user device with the relying party. The instructions configured to cause the computing device to authenticate the user device with the relying party further comprise instructions configured to cause the computing device to: receive an authentication challenge from the relying party; perform an authentication to generate a platform-specific authentication assertion; and provide the platform-specific authentication assertion to the relying party. The authentication entity is an authentication server, and wherein the instructions configured to cause the computing device to authenticate the user of the user device with a relying party and the authentication entity further comprise instructions configured to cause the computing device to: request, at the user device, provisioning of a platform-specific authentication credential from the relying party; and receive a one-time password from the relying party. Instructions configured to cause the computing device to provide the one-time password and federation credentials to the authentication server to establish the platform-specific authentication credential associated with the federation credentials. Instructions configured to cause the computing device to receive the platform-specific authentication credential from the authentication server.

### BRIEF DESCRIPTION OF THE DRAWINGS

FIG. 1 is a schematic diagram of an example computing environment in which the techniques disclosed herein can be implemented, in accordance with certain example implementations.

FIG. 2 is a swim-lane diagram of another example process for authenticating a user device, in accordance with certain example implementations.

FIG. 3 is a flow diagram of a process for authentication according to the disclosure that can be performed by a user device.

FIG. 4 is a flow diagram of a process for authentication according to the disclosure that can be performed by a user device.

FIG. 5 is a flow diagram of a process for authentication according to the disclosure that can be performed by a user device.

FIG. 6 is a flow diagram of a process for authentication according to the disclosure that can be performed by a user device.

FIG. 7 is a flow diagram of a process for authentication according to the disclosure that can be performed by a relying party.

FIG. 8 is a flow diagram of a process for authentication according to the disclosure that can be performed by a relying party.

FIG. 9 is a flow diagram of a process for authentication according to the disclosure that can be performed by a relying party.

FIG. 10 is a flow diagram of a process for authentication according to the disclosure that can be performed by a relying party.

FIG. 11 is a flow diagram of a process for authentication according to the disclosure that can be performed by a relying party.

FIG. 12 is a flow diagram of a process for authentication according to the disclosure that can be performed by an identity provider.

FIG. 13 is a flow diagram of a process for authentication according to the disclosure that can be performed by an identity provider.

FIG. 14 is a flow diagram of a process for authentication according to the disclosure that can be performed by an identity provider.

FIG. 15 is a block diagram of a computing device that can be used to implement various elements discussed herein.

Like reference symbols in the various drawings indicate like elements, in accordance with certain example implementations.

### DETAILED DESCRIPTION

Described herein are methods, systems, devices, computer readable media, and other implementations, for authenticating a user to access applications and/or services provided by one or more providers, referred to herein as relying parties. A relying party is a network entity that provides content, application(s), and/or service(s) but relies on another entity to authenticate the user. One entity responsible for authenticating the user is referred to herein an Identity Provider (IDP). A legacy IDP may be configured to support federation authentication protocols but may not be configured to support platform-enabled authentication protocols, such as the FIDO authentication protocols.

Platform-enabled authentication protocols use a combination of hardware and software, such as an operating system of the computing device on which the authentication platform is instantiated to implement the authentication. Platform-enabled authentication protocols are also referred to as “platform-specific authentication protocols” and “platform-specific authentication” herein. The hardware components can include sensors for obtaining biometric information to authenticate a user and/or other input devices that enable the user to input non-biometric inputs or unlock codes that can be used to authenticate the user. Platform-enabled authentication protocols create a unique authentication credential for each relying party. The user can use one device to authenticate with multiple relying parties, and each relying party will be associated with its own unique authentication credential. In contrast, an identity federation system (IDP) uses the same federation credential for a user across all service providers configured to utilize that federation credential for authentication purposes. Identity federation allows the user to leverage one authentication credential across multiple services providers and can facilitate services such as single-sign on (SSO) across multiple domains.

Some IDPs can implement platform-specific authentication in addition to identity federation protocols. However, in such a configuration, the user must depend on the IDP to maintain the confidentiality of the platform-specific authentication credentials. The IDP could potentially expose the user's platform-specific authentication credentials to relying parties that partner with that IDP. Such a disclosure would violate the user's privacy and allow the partnering IDPs to track the user across the services provided by these relying parties.

The techniques disclosed herein illustrate how platform-specific authentication can be used with a legacy IDP that is not configured to provide platform-specific authentication, which provides the benefits of leveraging platform-specific authentication and identity federation without the risk of exposing the platform-specific authentication credentials. Thus, the privacy of the user is maintained while befitting from the While the examples discussed herein refer to the use of FIDO authentication as the platform-specific authentication protocols, the techniques discussed herein are not limited to FIDO authentication and can be extended to use any platform-specific authentication protocols with a legacy IDP that is configured to provide federated identity services.

According to the techniques disclosed herein, a relying party that is configured to support platform-authentication protocols, such as FIDO, can be configured to use an authentication confirmation from a legacy IDP that is configured to provide federated authentication but not platform-specific authentication. The relying party can be configured to determine how the federation authentication confirmation is to be used in authenticating the user of a user device that is configured to support platform-specific authentication protocols. For example, the relying party may be configured to treat the legacy IDP as another type of authenticator that can be used to authenticate the user of the user device to access certain applications and/or services provided by the relying party. In other implementations, the relying party can be configured to require that the federation authentication confirmation be provided by the user device each time that the user device is authenticated to access applications and/or services provided by the relying party.

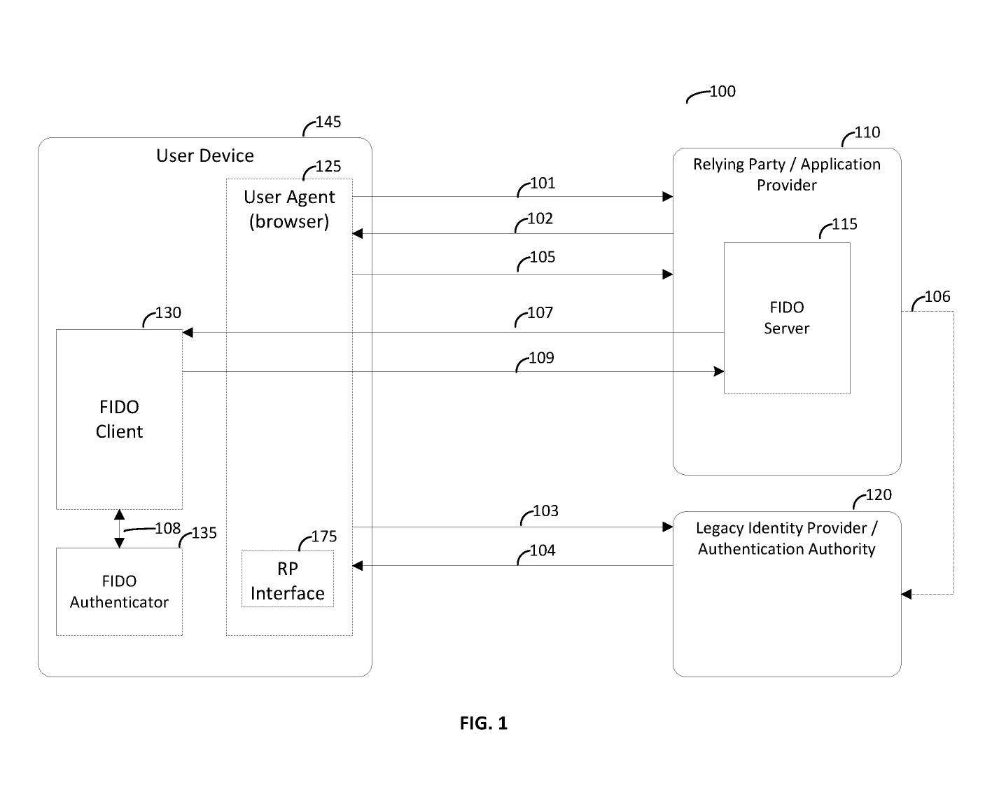

FIG. 1 is a schematic diagram of an example computing environment 100 in which the techniques disclosed herein can be implemented, in accordance with certain example implementations. The computing environment 100 includes a user device 145, a relying party 110 (the relying party can also be referred to as an “application provider”), and a legacy identity provider (IDP) 120 (the legacy IDP can also be referred to as an “authentication authority”). The relying party 110 can include a FIDO server 115. The user device 145 can include a user agent 125, a FIDO client 130, and a FIDO authenticator 135. The example computing environment 100 illustrates one example configuration of a computing environment in which a FIDO-enabled relying party 120 can interact with a user device 145 and a legacy IDP 120 that is not FIDO compliant. However, these techniques are not limited to FIDO. The user device 145 and the relying party 110 can implement other platform-specific authentication protocols instead of or in addition to FIDO.

The legacy IDP 120 is configured to provide identity management services by leveraging open standards to share user information across security and/or application domains to enable users to securely access the applications across those security domains. The legacy IDP 120 can be implemented by one or more computing devices, in which the functionality of the legacy IDP 120 can be implemented in software, hardware, or a combination thereof. The legacy IDP 120 can be configured implement various federation authentication protocols, such as Security Assertion Markup Language (SAML) or OpenID Connect (OIDC). The legacy IDP 120 can be configured to support single-sign on (S SO) in which an authentication event can be leveraged across application providers, such that the authentication confirmation provided by the legacy IDP 120 can be used to authenticate the user with subsequent attempts to access applications provided by the same or another application provider for which SSO is enabled.

The legacy IDP 120 allows the user of the user device 145 to authenticate with the legacy IDP 120 to access applications across an enterprise domain or across multiple domains. The legacy IDP 120 illustrated in FIG. 1 is not configured to support platform-specific authentication (such as FIDO), but can be used in conjunction with a relying party 120 and user device 145 that support platform-specific authentication as discussed in the examples that follow below. Platform-specific authentication and federation authentication protocols can be used in a complementary manner as will be illustrated in the examples discussed herein to provide elevated assurances of a user's identity through the use of both platform-specific and federation authentication. The platform-specific authentication can be extended to applications and services without requiring that platform-specific authentication be directly integrated with these applications and services. The relying party is responsible for determining how to combine the platform-specific and federated authentications. In some implementations, the relying party may treat the federation authentication as another type of authenticator that is acceptable for authenticating the user for access to certain types of applications and/or services. In other implementations, the relying party can be configured to require that the federation authentication confirmation be provided by the user device each time that the user device is authenticated to access applications and/or services provided by the relying party.

The relying party 110 is configured to support platform-specific authentication (FIDO in this example) and is configured to operate with a user device 145 which is also configured to support platform-specific authentication and the legacy IDP 120 to leverage the benefits of both federated authentication and platform-specific authentication. The relying party 110 can be implemented by one or more computing devices, in which the functionality of relying party 110 can be implemented in software, hardware, or a combination thereof.

The functionality of the user device 145 can be implemented in software, hardware, or a combination thereof. The user device 145 can be a mobile computing device, such as a smartphone, a laptop computer system, or a wearable computing device, such as a smartwatch. The user device 145 can also be computing device that is substantially stationary, which may be movable but is typically not moved regularly, such as a desktop computing system, a game console, a set top box, or other such computing device that is typically not moved.

FIG. 1 illustrates an example authentication process in which a user of the user device 145 can be authenticated using a legacy IDP 120 in addition to performing FIDO authentication between the user device 145 and the relying party 110. The use of FIDO in this example is not intended to limit the techniques disclosed herein to FIDO. Other platform-specific authentication protocols may be used instead of or addition to FIDO. The process illustrated in FIG. 1 can begin with the user registering the user device 145 with the relying party 110. The registration process can include prompting the user to select an available FIDO authenticator 135 from one or more FIDO authenticators that may be implemented on the user device 145. A FIDO authenticator can use various techniques to authenticate the user of the user device 145. A FIDO authenticator can be associated with a private key-public key pair. The private key is kept secret by the user device 145 while the public key can be provided to a FIDO-enabled relying party that can use the public key to verify that the user device 145 has signed a challenge value provided by the relying party 110. Access to the private keys must be unlocked by the user providing an appropriate authentication input, such as biometric information or an unlock code. A FIDO authenticator can be configured to use biometric information to authenticate the user of the user device 145 by capturing a fingerprint of the user using a fingerprint reader, by using facial or iris recognition by capturing an image of the user's face or iris using an imaging component of the user device 145, by using voice recognition by capturing user vocalizations using a microphone of the user device 145, and/or via other biometric techniques. A separate key may be associated with each type of biometric information. A FIDO authenticator can use a PIN, a swipe pattern, a password, or other type of unlock code to unlock access to a private key. Each relying party 110 can indicate which types of authentication are acceptable for authenticating the user with that relying party 110. The keys generated for use in FIDO authentication are specific to a particular application domain, in contrast to federation authentication credentials which can be used for multiple relying parties across application domains.

The user device 145 can access the relying party 110 via the user agent 125 of the user device. The user agent 125 can be a browser application on the user device 145 or may be another type of application on the user device 145 that is configured to contact the relying party 110 to register the user device 145 to obtain access to one or more applications and/or services. The user agent 125 of the user device 145 can include a relying party application or interface 175 that is configured to facilitate communications with the relying party 110 over a network connection between the user device 145 and the relying party 110. The relying party interface 175 can also be implemented as a separate application or interface from the user agent 125, and the user agent 125 can be configured to communicate with the relying party interface 175 to facilitate communications with the relying party 110. In the example implementation of FIG. 1, the relying party 110 is configured to support FIDO authentication protocols via the FIDO server 115. The user agent 125 can be configured to register an authentication credential with the FIDO server 115 of the relying party 110.

The user agent 125 can be configured to direct the FIDO client 130 of the user device 145 to create a platform-specific authentication credential (in this example a FIDO credential) and the user agent 125 can be configured to send the platform-specific authentication credential and associated information to the FIDO server 115 of the relying party 110 (stage 101). The associated information can include at least a public key of a private key-public key pair associated with a FIDO authenticator 135 that the user device 145 can use to authenticate the user of the user device 145 to the relying party 110. More than one public key may be provided if more than one FIDO authenticator is implemented on the user device 145. Attestation information from the one or more FIDO authenticators can also be included in the additional information provided to the FIDO server 115 of the relying party 110. The attestation information can include information that allows the relying party 110 to confirm that the user of the user device 145 has been authenticated by the FIDO client 130 using a FIDO authenticator 135 and can include proof of possession of previously registered key material. The specific contents of the attestation information can vary from implementation to implementation, and can also depend on the type of platform-specific authentication being performed.

The relying party 110 can be configured to direct the user agent 125 to log into the legacy IDP 120 and to provide unique information for an authentication session, such as a one-time password (OTP) and/or other information (stage 102). The FIDO server 115 of the relying party 110 can be configured to generate the OTP and/or other unique information that is valid only for the authentication session between the relying party 110 and the user device 145. The OTP or other unique session-specific information can later be used by the user agent 125 of the user device 145 to augment an authentication confirmation from the legacy IDP 120 to demonstrate to the relying party 110 that the user device 145 was in possession of the authentication confirmation from the legacy IDP 120. The relying party 110 can be configured to use URL redirection or another redirection technique to direct the user agent 125 of the user device 145 to a login page of the legacy IDP 120 in which the user can provide federation credentials, such a username and password or other federation credentials. The redirect command from the relying party 110 can also send the OTP and/or other session-specific information to the legacy IDP 120 as a URL parameter.

The user agent 125 can then provide a federation credential to the legacy IDP 120. The user agent 125 can be configured to prompt the user of the user device 145 to provide a username and password and/or other federation credentials to the legacy IDP 120. The user agent 125 can be configured to send the federation credentials to the legacy IDP 120 (stage 103). The legacy IDP 120 is not configured to support platform-specific authentication and cannot utilize attestations from the FIDO authenticator or authenticators of the user device 145 to authenticate the user of the user device 145. However, the relying party 110 can be configured to leverage the federation authentication by the legacy IDP 120 when authenticating a user of the user device 145. The relying party 110 can be configured to redirect the user to the legacy IDP 120 to provide the federation credentials in order to receive the federation authentication confirmation from the legacy IDP 120 as part of the authentication process. Furthermore, because the platform-specific authentication credentials (FIDO authentication credentials in this example) are not disclosed to the legacy IDP 120, the risk that the platform-specific authentication credentials may be disclosed to other relying parties is avoided.

The legacy IDP 120 can be configured to receive the federation credentials and to authenticate the federation credentials. The legacy IDP 120 can be configured to provide an authentication confirmation to the user agent 125 (stage 104). The authentication confirmation can include an authentication token. The authentication token can be provided by the legacy IDP to indicate that the user of the user device 145 has been authenticated by the legacy IDP 120. The various examples discussed herein discuss the use of an authentication token, but other types of authentication confirmation may be utilized. An authentication token can include security credentials for a user and can include information about the user, such as the user's privileges for accessing specific content and/or applications. The authentication token can be used to authenticate the user and the authentication confirmation can provide information about the authentication that can be used by one or more application and/or service providers. The authentication token may be valid for applications and/or services provided by the relying party or provided by more than one relying party 110. For example, the authentication token may provide access to social media content, email content, an online shopping account, and/or other types of applications and/or services. The relying party 110 can determine how the federation authentication confirmation is to be used in authenticating the user of the user device 145. For example, the relying party 110 may be configured to treat the legacy IDP effectively as another type of authenticator that can be used to authenticate the user of the user device 145 to access certain applications and/or services.

The legacy IDP 120 can also provide a Uniform Resource Identifier (URI) to redirect the user agent 125 to the relying party 110. The relying party interface 175 of the user agent 125 can be configured to receive the authentication confirmation, to resolve a network address of the relying party 110 from the redirect URI, and to perform the redirect to the relying party 110. The URI of the relying party 110 can be determined from the HTTP request from the user agent 125 of the user device 145 in which the federation credentials and the OTP and/or other session specific information were provided to the legacy IDP 120.

After the redirect, the relying party application utilized by the user agent 125 can provide the authentication confirmation, such as an authentication token, augmented with the unique information for the session, such as the OTP and/or other session-specific information received in stage 102, to the relying party 110 (stage 105). The user agent 125 can be configured to digitally sign the OTP and/or other session-specific information with a public key associated with the user device 145 and to provide the digitally signed OTP and/or other session-specific information with the authentication confirmation to the legacy IDP 120. The user agent 125 can be configured to digitally sign the authentication confirmation in addition to or instead of the OTP and/or other session specific information and to provide the digitally signed authentication confirmation to the relying party 110.

The relying party 110 can be configured to validate the IDP authentication confirmation with the legacy IDP 120 (stage 106). The FIDO server 115 of the relying party 110 can be configured to validate the authentication confirmation received from the user agent 125 of the user device 145. For example, The FIDO server 115 can validate the digital signature of the OTP and/or other session-specific information and/or the authentication confirmation using the public key associated with the user device 145 that was provided to the FIDO server 115 in stage 101. The legacy IDP 120 can also be configured to associate the OTP and/or other session specific information provided by the user device 145 with the federation credentials. The legacy IDP 120 can provide the OTP and/or other session specific information to the FIDO server 115 of the relying party 110 responsive to the FIDO server 115 sending the federation authentication confirmation received from the user device 145 to the legacy IDP 120. If the OTP and/or other session specific information received from the legacy IDP 120 matches the OTP and/or other session specific information that the FIDO server 115 originally provided to the user device 145, then the relying party 110 can confirm the validity of the authentication confirmation.

The relying party 110 can be configured to send a challenge to the user device 145 to prompt authentication (stage 107). For example, the FIDO server 115 of the relying party 110 can be configured to send a challenge to the FIDO client 130 of the user device 145 responsive to prompt FIDO authentication of the user device 145. The FIDO server challenge prompts the FIDO client 130 to perform authentication FIDO authentication. The parameters for the FIDO authentication can be established between the user agent 125 and the FIDO server 115 in stage 101. Other types of platform-specific authentication may be performed where the relying party 110 and the user device 145 are configured to utilize other platform-specific authentication protocols instead of or in addition to FIDO.

An authenticator on the user device 145 can perform authentication (stage 108). For example, the FIDO client 130 prompts the FIDO authenticator 135 of the user device 145 to perform authentication. The user of the user device 145 can perform an authentication action associated with a FIDO authenticator, such as the FIDO authenticator 135. The FIDO authenticator 135 can generate an assertion and provide the assertion to the FIDO client 130. The user device 145 can include other types of platform-specific authenticators and can prompt one or more authenticators to perform an authentication action responsive to the challenge from the relying party 110 where the relying party 110 and the user device 145 are configured to utilize other platform-specific authentication protocols instead of or in addition to FIDO. The authentication can include biometric and/or other non-biometric authentication actions as discussed above.

The assertion from the authenticator can be send to the relying party 110 (stage 109). For example, the FIDO client 130 can then send the assertion obtained from the authenticator(s) to the relying party 110. The relying party 108 can be configured to verify the authentication of the assertion. The relying party 108 can be configured to make server-to-server calls to an Authentication Authority to obtain additional information for performing the authentication. The relying party 108 can be configured to provide the user device 145 with access to content and/or services responsive to the authentication being successful.

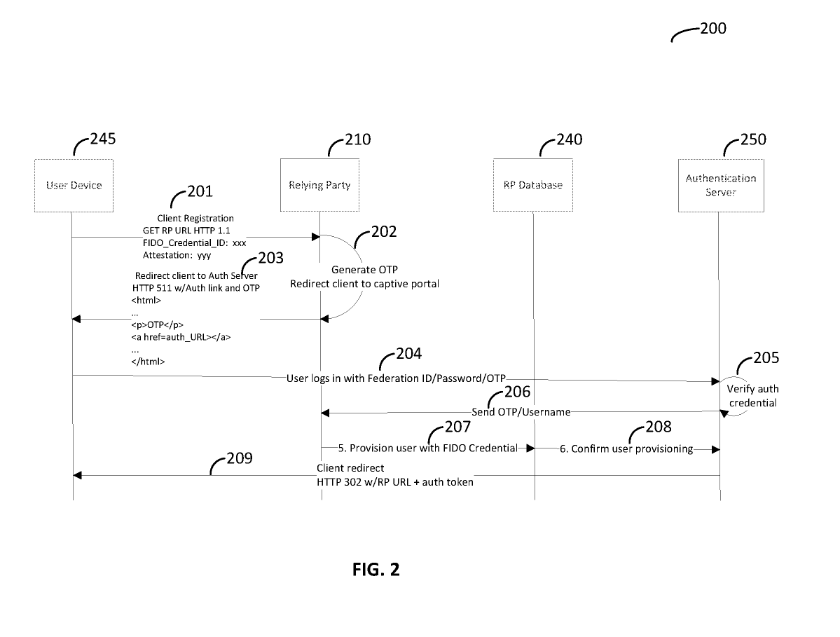

FIG. 2 is a swim-lane diagram of another example process 200 for authenticating a user device, in accordance with certain example implementations. The example call flow illustrated in FIG. 2 provides another technique through which a relying party can leverage both platform-specific authentication and a legacy IDP that is not configured to support platform-specific authentication. The example illustrated in FIG. 2 discusses the use of FIDO authentication as the platform-specific authentication, but the techniques disclosed herein are not limited to FIDO. Other platform-specific authentication techniques can be used. The process 200 can be implemented using an RP application or interface of a FIDO client of a user device 245, a relying party 210, a relying party (RP) database 240, and an authentication server 250. The RP application and the FIDO client of the user device 245 can be similar to the RP application and the FIDO client 130 of the user device 145 discussed above with respect to FIG. 1. The relying party 210 can be similar to the relying party 110 discussed above with respect to FIG. 1. The RP database 240 can be used to store platform-specific authentication credentials (in this example FIDO credentials) associated with users of user devices, such as the user device 145 discussed above with respect to FIG. 1 and also discussed with respect to the process 200. The RP database 240 can be maintained by the relying party 210 or may be stored on an external server or servers that are accessible by the relying party 210. The contents of the RP database 240 can be secured to prevent unauthorized access to the authentication credential stored therein. The relying party 210 can be configured to access the authentication credentials associated with a particular user device 245 when the user device 245 subsequent attempts to perform an authentication with the relying party 210 in the future. The relying party 210 can be configured to associate federation credentials associated with a user of the user device 245 with the platform-specific authentication credentials so that the federation credentials can be used as means for authenticating the user in addition to the platform-specific authentication techniques.

The authentication server 250 illustrated in FIG. 2 can be configured to perform authentication processing similar to the legacy IDP 120 discussed above with respect to FIG. 1. The authentication server 250 can be configured to receive and authenticate federation credentials from the user device on which the FIDO client is installed in the example configured of FIG. 2. The authentication server 250 can also be configured to receive federation credentials from user devices that implement federation authentication through other pathways that do not include FIDO authentication and are not illustrated in FIG. 2. The techniques illustrated in FIG. 2 utilize both platform-specific authentication (FIDO) and federation authentication techniques. The example process illustrated in FIG. 2 can be used to by a relying party 210 to utilize the federation authentication of the authentication server 250 in authenticating the user of the user device 245. For example, the relying party 210 may be configured to treat the authentication server 250 effectively as another type of authenticator that can be used to authenticate the user of the user device 245 to access certain applications and/or services provided by the relying party 210. In other implementations, the relying party 210 can be configured to require that the federation authentication confirmation be provided by the user device 245 each time that the user device 245 is authenticated to access applications and/or services provided by the relying party 210.

In the example implementation illustrated in FIG. 2, the RP interface of the user device can be configured to send an HTTP request to the relying party 210 (stage 201). The request can include a request for a platform-specific authentication credential, and attestation information and other information associated with the user device, such as a public key of a private key-public key pair associated with the user device. The platform-specific authentication credential is not generated by the user device as in the example process discussed above with respect to FIG. 1. Instead, the platform-specific authentication credential for the user device is provisioned by the relying party 210 later in the process 200.

The relying party 210 can be configured to receive the request and to direct the user device to log into the authentication server 250. The relying party 210 can be configured to generate a one-time password (OTP) and/or other session specific information (stage 202). The relying party 210 can send the OTP and/or other session specific information to the user device 245. The relying party 210 can be configured to direct the user device 245 to log into the authentication server 250 using a captive portal response (HTTP 511 response) which includes the OTP and/or other session-specific information (stage 203).

The user device 245 can be configured to receive the redirect response from the relying party 210, to extract the OTP and/or other session specific information from the redirect response, and to send an HTTP request to the authentication server 250 (stage 204). The HTTP request to the authentication server can include federation credentials (such as a username and/password and/or other federation credentials) and the OTP and/or other session-specific information provided by the relying party 210.

The authentication server 250 can be configured to verify the federation credentials (stage 205) and can be configured to send a message to the relying party that includes the OTP and/or other session-specific information provided by the relying party 210 and the username of the user of the user device 145. The username can be a username that was provided as part of the federation credentials. The authentication server 250 can be configured to send other information identifying the user instead of or in addition to the username.

The relying party 110 uses the OTP and the username received from the authentication server 250 to provision a FIDO authentication credential (stage 207). The relying party 210 generates the platform-specific authentication credential (a FIDO authentication credential in this example) for the user device 245 rather than the platform-specific authentication credential being generated by the user device 245 as in the example discussed above with respect to FIG. 1.

The authentication credential can be stored in the RP database 240 by the relying party 210 and forwarded to the authentication server 250 to confirm user provisioning has been completed (stage 208). The federation credentials can be associated with the platform-specific authentication credential in the RP database 240. The relying party 210 can then be configured to use the federation credentials as one means of authenticating the user device 245. The relying party 210 can be configured to use the federation credentials to authenticate the user to access one or more applications and/or services provided by the relying party 210. The relying party 210 can be configured to redirect the user device 245 to the authentication server 250 to provide the federation credentials and to obtain a federation authentication confirmation which the relying party 210 can use to authentication the user of the user device 245.

The authentication server 250 can then send a response to the user device 245 indicating that the provisioning has been completed successfully (stage 209). The response can be an HTTP response with a status code of 302, which can include a URI of the relying party 210 and which can redirect the user agent of the user device 245 to the relying party 210. The process 200 enables the relying party 210 to associate the authentication credential with the federation credential used by the authentication server 250. This technique allows the relying party to leverage the user onboarding of the legacy IDP (authentication server 250).

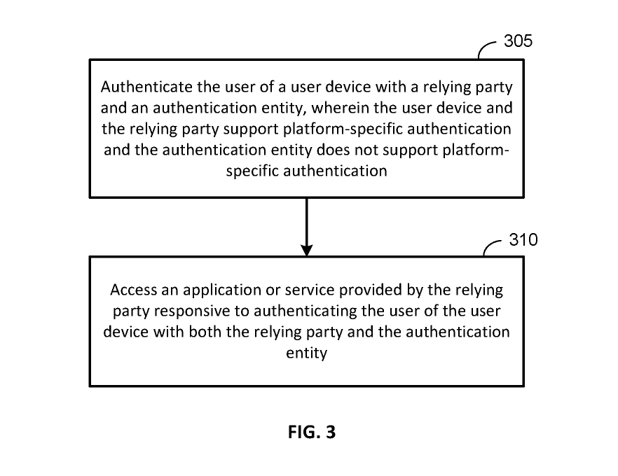

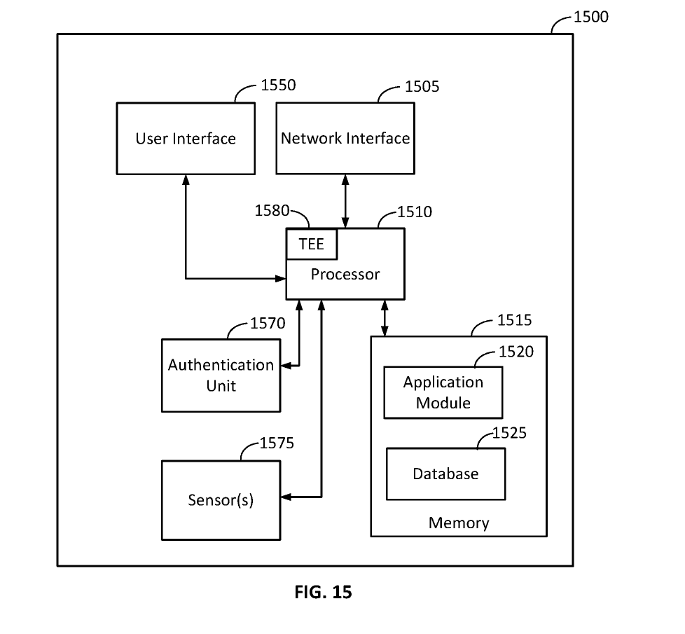

FIG. 3 is a flow diagram of an process for authentication according to the disclosure. The process illustrated in FIG. 3 can be implemented by a user device, which can provide the means for performing the various stages of the process of FIG. 3. The user device can be similar to user device 145 of FIG. 1 or user device 245 illustrated in FIG. 2, which can in turn, be implemented by a computing device, such as the example computing device 1500 illustrated in FIG. 15. The process illustrated in FIG. 3 can be used to implement, at least in part, the processes illustrated in FIG. 1 and/or FIG. 2. The order of the stages of the process can be altered and additional stages can be added and/or one or more of the stages discussed herein may be omitted in some implementations.

A user of a user device can be authenticated by a relying party and an authentication entity (stage 305). The user device and the relying party can be configured to support platform-specific authentication, such as but not limited to FIDO. The authentication entity can be configured to perform authentication using federation credentials, but is not configured to provide such platform-specific authentication. FIG. 1 illustrates one example of a user device 145 performing an authentication process with a relying party 110 and a legacy IDP 120. The relying party 110 can include a FIDO server 115 configured to perform platform-specific authentication with the user device 145, while the legacy IDP 120 is configured to provide identity management services by leveraging open standards to share user information across security and/or application domains to enable users to securely access the applications across those security domains. FIG. 2 illustrates an example of a user device 245 performing another authentication process with a relying party 210 and an authentication server 250 that includes both platform-specific authentication (FIDO in this example but these techniques are not limited to FIDO) and federation authentication techniques. The example process illustrated in FIG. 2 can be used to by a relying party 210 to utilize the federation authentication of the authentication server 250 in authenticating the user of the user device 245. Stage 305 can be implemented by either of the processes illustrated in FIGS. 1 and 2, but the techniques for authenticating the user device with a relying party are not limited to the specific techniques disclosed in FIGS. 1 and 2. The order of the stages of these processes may be altered from that illustrated in FIGS. 1 and 2 and one or more of the stages may omitted and/or one or more stages may be added to either of these processes.

An application or service provided by the relying party can be accessed responsive to authenticating the user of the user device with both the relying party and the authentication entity (stage 310). The user device can be configured to access content provided by the relying party, such as audio, video(s), text, image(s), and/or other content provided by the relying party. The user device can also be configured to access one or more services provided by the relying party, such as accessing and/or modifying sensitive information maintained by the relying party, such as corporate data, medical data, financial data, patient data, and/or other such sensitive information. The user device can also be configured to access an application provided by the relying party, such as a cloud-based or other such online application that can be utilized by the user of the user device. The examples discussed herein are merely intended to examples of the types of applications and/or services that the relying party may provide to the user device and are not intended to limit the techniques disclosed herein to these specific examples.

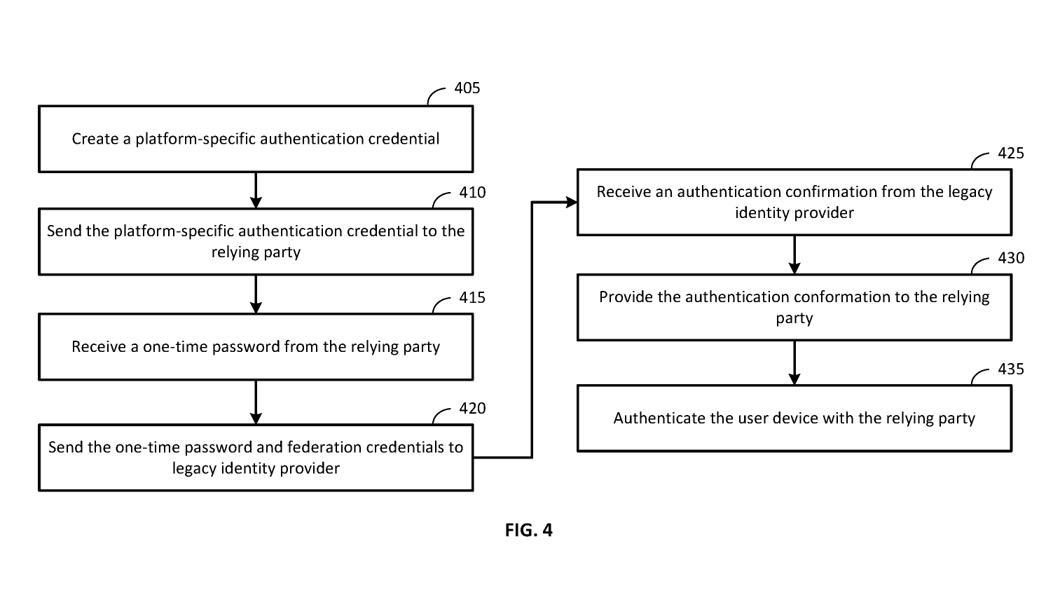

FIG. 4 is a flow diagram of an process for authentication according to the disclosure. The process illustrated in FIG. 4 can be implemented by a user device, which can provide the means for performing the various stages of the process of FIG. 4. The user device can be similar to user device 145 of FIG. 1 or user device 245 illustrated in FIG. 2, which can in turn, be implemented by a computing device, such as the example computing device 1500 illustrated in FIG. 15. The process illustrated in FIG. 4 can be used to implement, at least in part, stage 305 of the process illustrated in FIG. 3. The process illustrated in FIG. 4 can be used to implement, at least in part, the process illustrated in FIG. 1. The order of the stages of the process can be altered and additional stages can be added and/or one or more of the stages discussed herein may be omitted in some implementations.

A platform-specific authentication credential can be created (stage 405). The user device 145 can include a user agent 125 and a FIDO client 130 or other platform-specific authentication client. The user agent 125 can be configured to direct the FIDO client 130 or other platform-specific authentication client to create a platform-specific authentication credential (in this example a FIDO credential). The contents of the platform-specific authentication credential depend on the specific authentication platform that is being implemented. The examples illustrated herein utilize FIDO, but other platform-specific authentication techniques can be used instead of or in addition to FIDO.

The platform-specific authentication credential can be sent to the relying party (stage 410). The platform-specific authentication credential and additional associated information can be sent to the relying party 110. The associated information can include at least a public key of a private key-public key pair associated with a FIDO authenticator 135 that the user device 145 can use to authenticate the user of the user device 145 to the relying party 110. More than one public key may be provided if more than one FIDO authenticator is implemented on the user device 145. Attestation information from the one or more FIDO authenticators can also be included in the additional information provided to the FIDO server 115 of the relying party 110. The user agent 125 of the user device can be configured to send the platform-specific authentication credential and the additional associated information via a network interface of the user device 145.

A one-time password can be received from the relying party (stage 415). The FIDO server 115 of the relying party 110 can be configured to generate a one-time password (OTP) or other unique information that is valid only for the authentication session between the relying party 110 and the user device 145. The OTP or other unique session-specific information can later be used by the user agent 125 of the user device 145 to augment an authentication confirmation from the legacy IDP 120 to demonstrate to the relying party 110 that the user device 145 was in possession of the authentication confirmation from the legacy IDP 120. The OTP and/or other session-specific information can be received from the relying party 110 via a network interface of the user device.

The one-time password and federation credentials can be sent to legacy identity provider (stage 420). The relying party 110 can be configured to direct the user agent 125 to log into the legacy IDP 120 and to provide the unique information for an authentication session, such as the one-time password (OTP) and/or other information generated by the relying party 110 and which is valid only for the authentication session between the relying party 110 and the user device 145. The relying party 110 can be configured to use URL redirection to direct the user agent 125 of the user device 145 to a login page of the legacy IDP 120 in which the user can provide federation credentials, such a username and password or other federation credentials. The redirect can also send the OTP and/or other session-specific information to the legacy IDP 120 as a URL parameter. The user agent 125 can be configured to prompt the user of the user device 145 to provide a username and password and/or other federation credentials to the legacy IDP 120. The user agent 125 can be configured to send the federation credentials to the legacy IDP 120. The legacy IDP 120 is not configured to support platform-specific authentication and cannot utilize attestations from the FIDO authenticator or authenticators of the user device 145 to authenticate the user of the user device 145. However, the relying party 110 can be configured to leverage the federation authentication by the legacy IDP 120 when authenticating a user of the user device 145. Because the platform-specific authentication credentials (FIDO authentication credentials in this example) are not disclosed to the legacy IDP 120, the risk that the platform-specific authentication credentials may be disclosed to other relying parties is avoided.

An authentication confirmation can be received from the legacy identity provider (stage 425). The authentication confirmation can include an authentication token. The authentication token can be provided by the legacy IDP to indicate that the user of the user device 145 has been authenticated by the legacy IDP 120. The authentication token can be used to authenticate the user, and the authentication confirmation can provide information about the authentication that can be used by one or more application and/or service providers. The authentication token may be valid for applications and/or services provided by the relying party or provided by more than one relying party 110. For example, the authentication token may provide access to social media content, email content, an online shopping account, and/or other types of applications and/or services. The relying party 110 can determine how the federation authentication confirmation is to be used in authenticating the user of the user device 145. For example, the relying party 110 may be configured to treat the legacy IDP as another type of authenticator that can be used to authenticate the user of the user device 145 to access certain applications and/or services.

The authentication confirmation can be provided to the relying party (stage 430). The user agent 125 can be configured to send the authentication confirmation received from the legacy IDP 120 to the relying party 110 via a network interface of the user device 145. The user agent 125 can be configured to digitally sign the OTP and/or other session-specific information with a public key associated with the user device 145 and to provide the digitally signed OTP and/or other session-specific information with the authentication confirmation to the legacy IDP 120. The user agent 125 can be configured to digitally sign the authentication confirmation in addition to or instead of the OTP and/or other session specific information and to provide the digitally signed authentication confirmation to the relying party 110.

The legacy IDP 120 can also provide a Uniform Resource Identifier (URI) to redirect the user agent 125 to the relying party 110. The relying party application of the user agent 125 can be configured to receive the authentication confirmation, to resolve a network address of the relying party 110 from the redirect URI, and to perform the redirect to the relying party 110. The URI of the relying party 110 can be determined from the HTTP request from the user agent 125 of the user device 145 in which the federation credentials and the OTP and/or other session specific information were provided to the legacy IDP 120.

The user device can be authenticated with the relying party (stage 435). The relying party 110 can be configured to validate the authentication confirmation received from the user device by validating a digital signature of the OTP and/or other session-specific information and/or the authentication confirmation using the public key associated with the user device 145 that was provided to the FIDO server with the additional information in stage 410. The relying party 110 can also be configured to send a challenge to the user device to cause the FIDO client 130 to perform authentication FIDO authentication. An example of such a process is illustrated in FIG. 5.

FIG. 5 is a flow diagram of an process for authentication according to the disclosure. The process illustrated in FIG. 5 can be implemented by a user device, which can provide the means for performing the various stages of the process of FIG. 5. The user device can be similar to user device 145 of FIG. 1 or user device 245 illustrated in FIG. 2, which can in turn, be implemented by a computing device, such as the example computing device 1500 illustrated in FIG. 15. The process illustrated in FIG. 5 can be used to implement, at least in part, stage 435 of the process illustrated in FIG. 4. The process illustrated in FIG. 5 can be used to implement, at least in part, the process illustrated in FIG. 1. The order of the stages of the process can be altered and additional stages can be added and/or one or more of the stages discussed herein may be omitted in some implementations.

An authentication challenge can be received from the relying party (stage 505). The relying party 110 can also be configured to send a challenge to the user device to cause the FIDO client 130 to perform authentication FIDO authentication. The relying party 110 and the user device can be configured to support other platform-specific authentication challenges.

An authentication can be performed to generate a platform-specific authentication assertion (stage 510). The user of the user device 145 can perform an authentication action associated with a FIDO authenticator, such as the FIDO authenticator 135. The FIDO authenticator 135 can generate an assertion and provide the assertion to the FIDO client 130. The user device 145 can include other types of platform-specific authenticators and can prompt one or more authenticators to perform an authentication action responsive to the challenge from the relying party 110 where the relying party 110 and the user device 145 are configured to utilize other platform-specific authentication protocols instead of or in addition to FIDO.

The platform-specific authentication assertion can be provided to the relying party (stage 515). The FIDO authenticator 135 of the user device can be configured to send the assertion to the relying party via network interface or other communication interface of the user device.

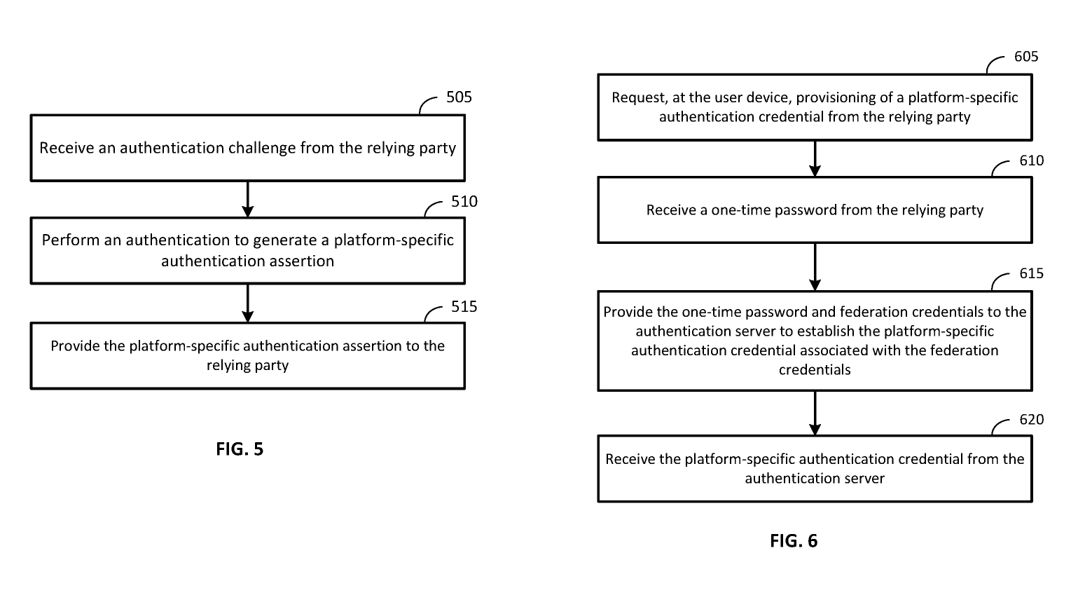

FIG. 6 is a flow diagram of an process for authentication according to the disclosure. The process illustrated in FIG. 6 can be implemented by a user device, which can provide the means for performing the various stages of the process of FIG. 6. The user device can be similar to user device 145 of FIG. 1 or user device 245 illustrated in FIG. 2, which can in turn, be implemented by a computing device, such as the example computing device 1500 illustrated in FIG. 15. The process illustrated in FIG. 6 can be used to implement, at least in part, stage 305 of the process illustrated in FIG. 3. The process illustrated in FIG. 6 can be used to implement, at least in part, the process illustrated in FIG. 2. The order of the stages of the process can be altered and additional stages can be added and/or one or more of the stages discussed herein may be omitted in some implementations.

A request can be sent to the relying party for provisioning of a platform-specific authentication credential (stage 605). The relying party (RP) application of the FIDO client 130 of the user device can be configured to send an HTTP request to the relying party 210 to request the provisioning of the platform-specific authentication credential. The request can include a request for a platform-specific authentication credential, and attestation information and other information associated with the user device, such as a public key of a private key-public key pair associated with the user device. The platform-specific authentication credential is not generated by the user device as in the example process discussed above with respect to FIG. 1. Instead, the platform-specific authentication credential for the user device is provisioned by the relying party 210 later in the process 200.

A one-time password can be received from the relying party 110 (stage 610). The relying party 210 can be configured to receive the request for provisioning of a platform-specific authentication credential and to direct the user device to log into the authentication server 250. The relying party 210 can be configured to generate a one-time password (OTP) and/or other session specific information responsive to receiving the request from the user device. The relying party 210 can then be configured to send the OTP and/or other session specific information to the user device, and the user device can be configured to receive the OTP and/or other session specific information via a network interface or other communication interface. The relying party 210 can be configured to direct the user device to log into the authentication server 250 using a captive portal response (HTTP 511 response) which includes the OTP and/or other session-specific information.

The one-time password and federation credentials can be provided to an authentication server to establish the platform-specific authentication credential associated with the federation credentials (stage 615). The user device can be configured to receive the redirect response from the relying party 210, to extract the OTP and/or other session specific information from the redirect response, and to send an HTTP request to the authentication server 250. The HTTP request to the authentication server can include federation credentials (such as a username and/password and/or other federation credentials) and the OTP and/or other session-specific information provided by the relying party 210.

The platform-specific authentication credential can be received from the authentication server (stage 620). The authentication server 250 can be configured to verify the federation credentials and can be configured to send a message to the relying party that includes the OTP and/or other session-specific information provided by the relying party 210 and the username of the user of the user device 145. The relying party 110 can be configured use the OTP and the username received from the authentication server 250 to provision a FIDO authentication credential. The relying party 210 generates the platform-specific authentication credential (a FIDO authentication credential in this example) for the user device 245 rather than the platform-specific authentication credential being generated by the user device 245 as in the example discussed above with respect to FIG. 1. The authentication credential is stored in the RP database 240 by the relying party 210 and forwarded to the authentication server 250 to confirm user provisioning has been completed. The federation credentials can be associated with the platform-specific authentication credential in the RP database 240. The relying party 210 can then be configured to use the federation credentials as one means of authenticating the user device 245. The relying party 210 can be configured to use the federation credentials to authenticate the user to access one or more applications and/or services provided by the relying party 210. The relying party 210 can be configured to redirect the user device 245 to the authentication server 250 to provide the federation credentials and to obtain a federation authentication confirmation which the relying party 210 can use to authentication the user of the user device 245. The authentication server 250 can then send a response to the user device 245 indicating that the provisioning has been completed. The response can be an HTTP response with a status code of 302, which can include a URI of the relying party 210 and which can redirect the user agent of the user device 245 to the relying party 210. The process 200 enables the relying party 210 to associate the authentication credential with the federation credential used by the authentication server 250. This technique allows the relying party to leverage the user onboarding of the legacy IDP (authentication server 250).

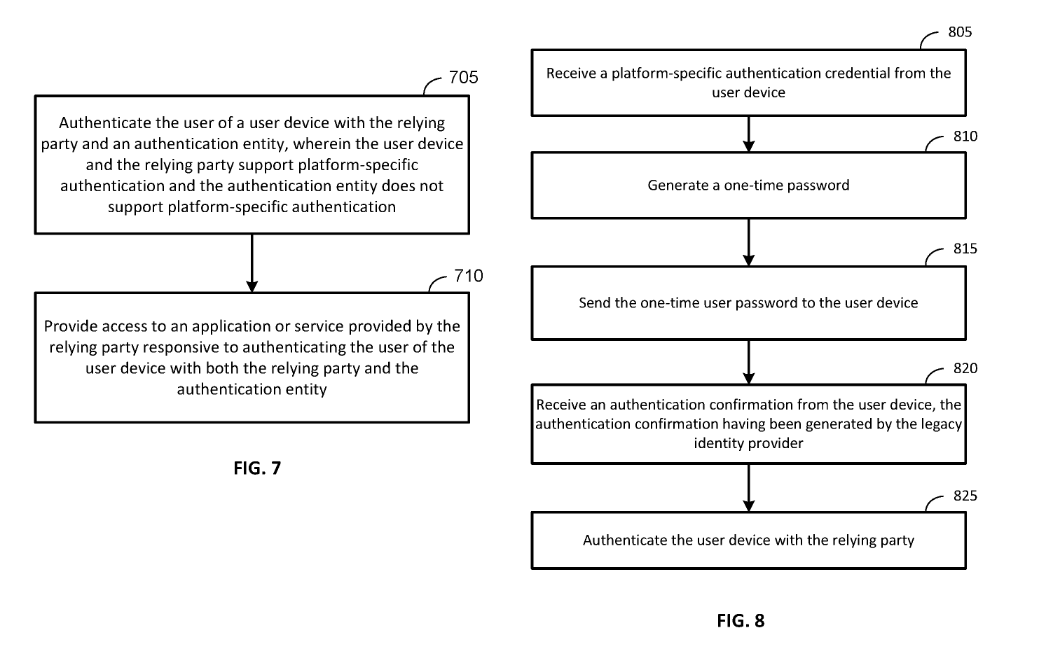

FIG. 7 is a flow diagram of an process for authentication according to the disclosure. The process illustrated in FIG. 7 can be implemented by a relying party, which can provide the means for performing the various stages of the process of FIG. 7 The relying party can be similar to relying party 110 of FIG. 1 or the relying party 210 illustrated in FIG. 2, which can in turn, be implemented by a computing device, such as the example computing device 1500 illustrated in FIG. 15. The process illustrated in FIG. 7 can be used to implement, at least in part, the process illustrated in FIG. 1. The order of the stages of the process can be altered and additional stages can be added and/or one or more of the stages discussed herein may be omitted in some implementations.

A user of a user device can be authenticated by a relying party and an authentication entity (stage 705). The user device and the relying party can be configured to support platform-specific authentication, such as but not limited to FIDO. The authentication entity can be configured to perform authentication using federation credentials, but is not configured to provide such platform-specific authentication. The relying party can be configured to authenticate the user device according to the techniques illustrated in FIG. 1 and/or FIG. 2 discussed above. The order of the stages of these processes may be altered from that illustrated in FIGS. 1 and 2 and one or more of the stages may omitted and/or one or more stages may be added to either of these processes.

Access to an application or service provided by the relying party responsive can be provided to the user device responsive to authenticating the user of the user device with both the relying party and the authentication entity (stage 710). The relying partyy can be configured to provide content, such as audio, video(s), text, image(s), and/or other content which can be accessed by the user device responsive to the authentication being successful. The relying party can also be configured to provide one or more services to the user device, such as accessing and/or modifying sensitive information maintained by the relying party, such as corporate data, medical data, financial data, patient data, and/or other such sensitive information. The relying party can also be configured to provide access to an application to the user device, such as a cloud-based or other such online application that can be utilized by the user of the user device. The examples discussed herein are merely intended to examples of the types of applications and/or services that the relying party may provide to the user device and are not intended to limit the techniques disclosed herein to these specific examples.

FIG. 8 is a flow diagram of an process for authentication according to the disclosure. The process illustrated in FIG. 8 can be implemented by a relying party, which can provide the means for performing the various stages of the process of FIG. 8. The relying party can be similar to relying party 110 of FIG. 1 or the relying party 210 illustrated in FIG. 2, which can in turn, be implemented by a computing device, such as the example computing device 1500 illustrated in FIG. 15. The process illustrated in FIG. 8 can be used to implement, at least in part, stage 705 of the process illustrated in FIG. 1. The process illustrated in FIG. 8 can be used to implement, at least in part, the process illustrated in FIG. 1. The order of the stages of the process can be altered and additional stages can be added and/or one or more of the stages discussed herein may be omitted in some implementations.

A platform-specific authentication credential can be received from the user device (stage 805). The user agent 125 of the user device can be configured to direct the FIDO client 130 or other platform-specific authentication client to create a platform-specific authentication credential (in this example a FIDO credential). The contents of the platform-specific authentication credential depend on the specific authentication platform that is being implemented. Additional associated information can also be received from the user device. The associated information can include at least a public key of a private key-public key pair associated with a FIDO authenticator 135 that the user device 145 can use to authenticate the user of the user device 145 to the relying party 110. More than one public key may be provided if more than one FIDO authenticator is implemented on the user device 145. Attestation information from the one or more FIDO authenticators can also be included in the additional information provided to the FIDO server 115 of the relying party 110. The user agent 125 of the user device can be configured to send the platform-specific authentication credential and the additional associated information via a network interface of the user device.

A one-time password can be generated (stage 810) and the one-time password can be send to the user device (stage 815). The FIDO server 115 of the relying party 110 can be configured to generate a one-time password (OTP) or other unique information that is valid only for the authentication session between the relying party 110 and the user device 145. The OTP or other unique session-specific information can later be used by the user agent 125 of the user device 145 to augment an authentication confirmation from the legacy IDP 120 to demonstrate to the relying party 110 that the user device 145 was in possession of the authentication confirmation from the legacy IDP 120. The OTP and/or other session-specific information can be sent to the user device from the relying party via a network interface of the relying party.

The relying party 110 can be configured to direct the user agent 125 of the user device to log into the legacy IDP 120 and to provide the unique information for an authentication session, such as the one-time password (OTP) and/or other information generated by the relying party 110 and which is valid only for the authentication session between the relying party 110 and the user device 145. The relying party 110 can be configured to use URL redirection to direct the user agent 125 of the user device 145 to a login page of the legacy IDP 120 in which the user can provide federation credentials, such a username and password or other federation credentials. The redirect can also send the OTP and/or other session-specific information to the legacy IDP 120 as a URL parameter. The user agent 125 can be configured to prompt the user of the user device 145 to provide a username and password and/or other federation credentials to the legacy IDP 120. The user agent 125 can be configured to send the federation credentials to the legacy IDP 120. The legacy IDP 120 is not configured to support platform-specific authentication and cannot utilize attestations from the FIDO authenticator or authenticators of the user device 145 to authenticate the user of the user device 145. However, the relying party 110 can be configured to leverage the federation authentication by the legacy IDP 120 when authenticating a user of the user device 145. Because the platform-specific authentication credentials (FIDO authentication credentials in this example) are not disclosed to the legacy IDP 120, the risk that the platform-specific authentication credentials may be disclosed to other relying parties is avoided.

An authentication confirmation can be received from the user device (stage 820). The authentication confirmation can be generated by the legacy IDP 120 and send to the user device. The user agent 125 of user device 145 can be configured to send the authentication confirmation received from the legacy IDP 120 to the relying party 110. The user agent 125 can be configured to digitally sign the OTP and/or other session-specific information with a public key associated with the user device 145 and to provide the digitally signed OTP and/or other session-specific information with the authentication confirmation to the legacy IDP 120. The user agent 125 can be configured to digitally sign the authentication confirmation in addition to or instead of the OTP and/or other session specific information and to provide the digitally signed authentication confirmation to the relying party 110.

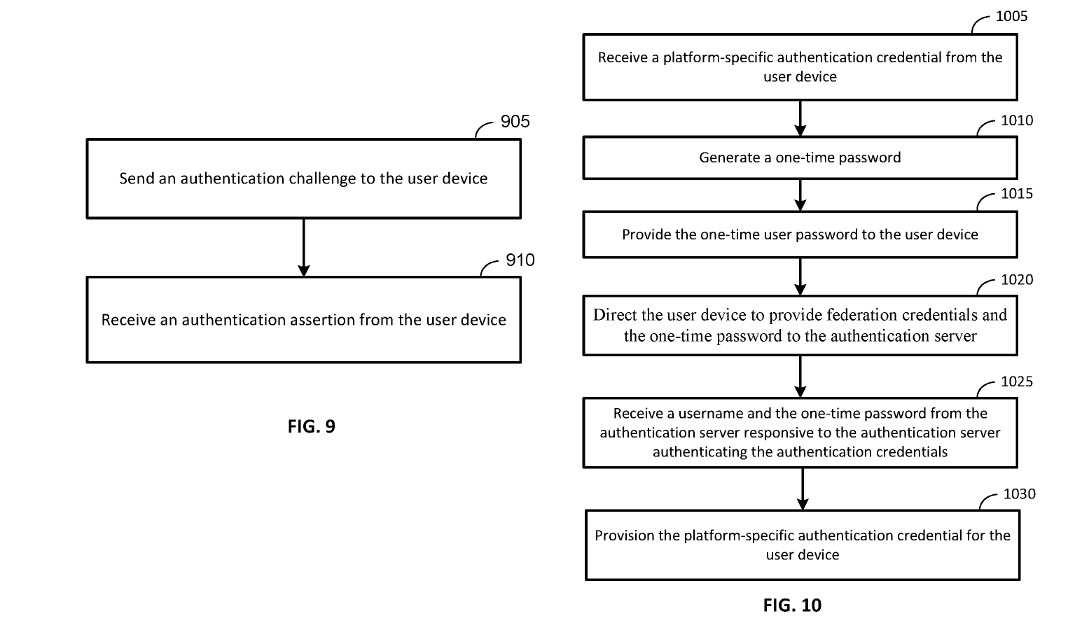

The user device can authenticated with the relying party 110 (stage 825). The relying party 110 can be configured to validate the authentication confirmation received from the user device by validating a digital signature of the OTP and/or other session-specific information and/or the authentication confirmation using the public key associated with the user device 145 that was provided to the FIDO server with the additional information in stage 410. The relying party 110 can also be configured to send a challenge to the user device to cause the FIDO client 130 to perform authentication FIDO authentication. An example of such a process is illustrated in FIG. 9.

FIG. 9 is a flow diagram of an process for authentication according to the disclosure. The process illustrated in FIG. 9 can be implemented by a relying party, which can provide the means for performing the various stages of the process of FIG. 9. The relying party can be similar to relying party 110 of FIG. 1 or the relying party 210 illustrated in FIG. 2, which can in turn, be implemented by a computing device, such as the example computing device 1500 illustrated in FIG. 15. The process illustrated in FIG. 9 can be used to implement, at least in part, stage 825 of the process illustrated in FIG. 8. The process illustrated in FIG. 9 can be used to implement, at least in part, the process illustrated in FIG. 1. The order of the stages of the process can be altered and additional stages can be added and/or one or more of the stages discussed herein may be omitted in some implementations.

An authentication challenge can be sent to the user device (stage 905). The relying party 110 can be configured to send a challenge to the user device to cause the FIDO client 130 to perform authentication FIDO authentication. The relying party 110 and the user device can be configured to support other platform-specific authentication techniques in addition to or instead of FIDO and an authentication challenge appropriate to the platform-specific authentication techniques being utilized can be sent by the relying party.

A platform-specific authentication assertion can be provided to the relying party (stage 910). The FIDO authenticator 135 of the user device can be configured to generate an assertion and to send the assertion to the relying party via network interface or other communication interface of the user device. The assertion can be generated responsive to the user being authenticated. No assertion is generated or sent if the authentication fails.

FIG. 10 is a flow diagram of an process for authentication according to the disclosure. The process illustrated in FIG. 10 can be implemented by a user device, which can provide the means for performing the various stages of the process of FIG. 10. The relying party can be similar to relying party 110 of FIG. 1 or the relying party 210 illustrated in FIG. 2, which can in turn, be implemented by a computing device, such as the example computing device 1500 illustrated in FIG. 15. The process illustrated in FIG. 10 can be used to implement, at least in part, stage 705 of the process illustrated in FIG. 7. The process illustrated in FIG. 10 can be used to implement, at least in part, the process illustrated in FIG. 2. The order of the stages of the process can be altered and additional stages can be added and/or one or more of the stages discussed herein may be omitted in some implementations.

A request can be for provisioning of a platform-specific authentication credential can be received from the user device (stage 1005). The relying party (RP) application of the FIDO client 130 of the user device can be configured to send an HTTP request to the relying party 210 to request the provisioning of the platform-specific authentication credential. The request can include a request for a platform-specific authentication credential, and attestation information and other information associated with the user device, such as a public key of a private key-public key pair associated with the user device. The platform-specific authentication credential is not generated by the user device as in the example process discussed above with respect to FIG. 1. Instead, the platform-specific authentication credential for the user device is provisioned by the relying party 210 later in the process 200.

A one-time password can be generated by the relying party 110 (stage 1010) and the one-time password can be sent to the user device (stage 1015). The relying party 210 can be configured to receive the request for provisioning of a platform-specific authentication credential and to direct the user device to log into the authentication server 250. The relying party 210 can be configured to generate a one-time password (OTP) and/or other session specific information responsive to receiving the request from the user device. The relying party 210 can then be configured to send the OTP and/or other session specific information to the user device, and the user device can be configured to receive the OTP and/or other session specific information via a network interface or other communication interface.

The user device can be directed to provide the federation credentials and the one-time password to the authentication server (stage 1020). The relying party 210 can be configured to direct the user device to log into the authentication server 250 using a captive portal response (HTTP 511 response) which includes the OTP and/or other session-specific information.

A username for the user of the user device and the one-time password can be received from the authentication server responsive to the authentication server authenticating the authentication credentials of the user device (stage 1025). The user device can be configured to receive the redirect response from the relying party 210, to extract the OTP and/or other session specific information from the redirect response, and to send an HTTP request to the authentication server 250. The HTTP request to the authentication server can include federation credentials (such as a username and/password and/or other federation credentials) and the OTP and/or other session-specific information provided by the relying party 210. The authentication server 250 can be configured to verify the federation credentials and can be configured to send a message to the relying party that includes the OTP and/or other session-specific information provided by the relying party 210 and the username of the user of the user device 145.

The platform-specific authentication credential for the user device can then be provisioned (stage 1030). The relying party 110 can be configured use the OTP and the username received from the authentication server 250 to provision a FIDO authentication credential. The relying party 210 generates the platform-specific authentication credential (a FIDO authentication credential in this example) for the user device 245 rather than the platform-specific authentication credential being generated by the user device 245 as in the example discussed above with respect to FIG. 1. The authentication credential is stored in the RP database 240 by the relying party 210 and forwarded to the authentication server 250 to confirm user provisioning has been completed. The federation credentials can be associated with the platform-specific authentication credential in the RP database 240. The relying party 210 can then be configured to use the federation credentials as one means of authenticating the user device 245. The relying party 210 can be configured to use the federation credentials to authenticate the user to access one or more applications and/or services provided by the relying party 210. The relying party 210 can be configured to redirect the user device 245 to the authentication server 250 to provide the federation credentials and to obtain a federation authentication confirmation which the relying party 210 can use to authentication the user of the user device 245. The authentication server 250 can then send a response to the user device 245 indicating that the provisioning has been completed. The response can be an HTTP response with a status code of 302, which can include a URI of the relying party 210 and which can redirect the user agent of the user device 245 to the relying party 210. The process 200 enables the relying party 210 to associate the authentication credential with the federation credential used by the authentication server 250. This technique allows the relying party to leverage the user onboarding of the legacy IDP (authentication server 250).

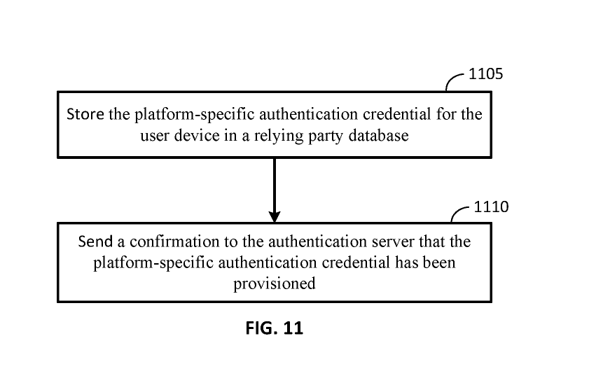

FIG. 11 is a flow diagram of an process for authentication according to the disclosure. The process illustrated in FIG. 10 can be implemented by a user device, which can provide the means for performing the various stages of the process of FIG. 11. The relying party can be similar to relying party 110 of FIG. 1 or the relying party 210 illustrated in FIG. 2, which can in turn, be implemented by a computing device, such as the example computing device 1500 illustrated in FIG. 15. The process illustrated in FIG. 11 can be used to implement, at least in part, additional stages to the process of FIG. 10. The process illustrated in FIG. 11 can be used to implement, at least in part, the process illustrated in FIG. 2. The order of the stages of the process can be altered and additional stages can be added and/or one or more of the stages discussed herein may be omitted in some implementations.

The platform-specific authentication credentials for the user device can be stored (stage 1105). The relying party 110 can be configured to store the platform-specific authentication credentials for the user device in a relying party database. The relying party 110 can store authentication credentials for multiple user devices in the relying party database. The federation credentials can be associated with the platform-specific authentication credential in the RP database 240. The relying party 210 can then be configured to use the federation credentials as one means of authenticating the user device 245. The relying party 110 can retrieve the authentication credentials from the database for authenticating the user device. The relying party 210 can be configured to use the federation credentials to authenticate the user to access one or more applications and/or services provided by the relying party 210.

A confirmation can be sent to the authentication server indicating that the platform-specific authentication credential has been provisioned (stage 1110). The relying party 210 can be configured to redirect the user device 245 to the authentication server 250 to provide the federation credentials and to obtain a federation authentication confirmation which the relying party 210 can use to authentication the user of the user device 245.

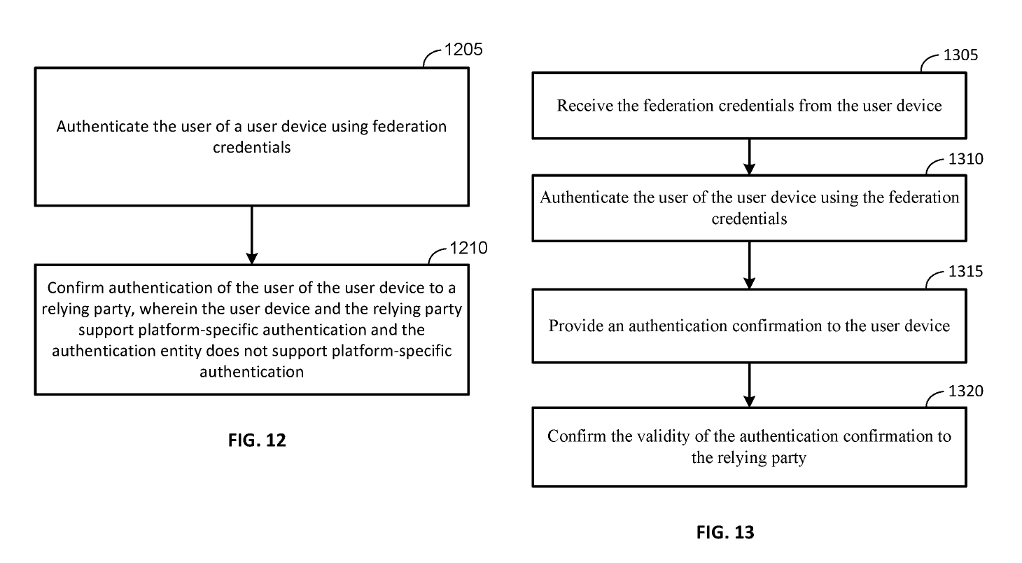

FIG. 12 is a flow diagram of an process for authentication according to the disclosure. The process illustrated in FIG. 12 can be implemented by a legacy identity provider, which can provide the means for performing the various stages of the process of FIG. 12. The legacy identity provider can be similar to legacy IDP 120 of FIG. 1 or the authentication server 250 illustrated in FIG. 2, which can in turn, be implemented by a computing device, such as the example computing device 1500 illustrated in FIG. 15. The process illustrated in FIG. 12 can be used to implement, at least in part, the processes illustrated in FIG. 1 and/or FIG. 2. The order of the stages of the process can be altered and additional stages can be added and/or one or more of the stages discussed herein may be omitted in some implementations.

The user of a user device can be authenticated using federation credentials (stage 1205). The authentication entity can be configured to perform authentication using federation credentials, but is not configured to provide such platform-specific authentication. FIG. 1 illustrates one example of a user device 145 performing an authentication process with a relying party 110 and a legacy IDP 120. The relying party 110 can include a FIDO server 115 configured to perform platform-specific authentication with the user device 145, while the legacy IDP 120 is configured to provide identity management services by leveraging open standards to share user information across security and/or application domains to enable users to securely access the applications across those security domains. FIG. 2 illustrates an example of a user device 245 performing another authentication process with a relying party 210 and an authentication server 250 that includes both platform-specific authentication (FIDO in this example but these techniques are not limited to FIDO) and federation authentication techniques. The example process illustrated in FIG. 2 can be used to by a relying party 210 to utilize the federation authentication of the authentication server 250 in authenticating the user of the user device 245. Stage 1205 can be implemented by either of the processes illustrated in FIGS. 1 and 2. The order of the stages of these processes may be altered from that illustrated in FIGS. 1 and 2 and one or more of the stages may omitted and/or one or more stages may be added to either of these processes.

The authentication of user of the user device can be confirmed to a relying party (stage 1210). The user device and the relying party support platform-specific authentication and the authentication entity does not support platform-specific authentication. The legacy IDP 120 or the authentication server 250 can be configured to confirm to the relying party that the user has been authentication using federation credentials. The relying party can associate the federation credentials with the platform-specific authentication credentials for the user (such as FIDO credentials) and can use the federation credentials as one means for authenticating the user of the user device.

FIG. 13 is a flow diagram of an process for authentication according to the disclosure. The process illustrated in FIG. 13 can be implemented by a legacy identity provider, which can provide the means for performing the various stages of the process of FIG. 13. The legacy identity provider can be similar to legacy IDP 120 of FIG. 1 or the authentication server 250 illustrated in FIG. 2, which can in turn, be implemented by a computing device, such as the example computing device 1500 illustrated in FIG. 15. The process illustrated in FIG. 13 can be used to implement, at least in part, stage 1205 of the process illustrated in FIG. 12. The process illustrated in FIG. 13 can be used to implement, at least in part, the processes illustrated in FIG. 1. The order of the stages of the process can be altered and additional stages can be added and/or one or more of the stages discussed herein may be omitted in some implementations.

Federation credentials can be received from a user device (stage 1305). The user device can provide federation credentials, such a username and password or other federation credentials to the legacy IDP 120 or the authentication server 250.

The user of the user device can be authenticated using the federation credentials (stage 1310). The legacy IDP 120 or the authentication server 250 can authenticate the user of the user device using the federation credentials that were provided in stage 1305.

An authentication confirmation can be provided to the user device (stage 1315). The authentication confirmation can include an authentication token. The authentication token can be provided by the legacy IDP 120 or the authentication server 250 to indicate that the user of the user device 145 has been authenticated by the legacy IDP 120 or the authentication server 250. The authentication token can be used to authenticate the user and the authentication confirmation can provide information about the authentication that can be used by one or more application and/or service providers. The authentication token may be valid for applications and/or services provided by the relying party or provided by more than one relying party 110. For example, the authentication token may provide access to social media content, email content, an online shopping account, and/or other types of applications and/or services. The relying party 110 can determine how the federation authentication confirmation is to be used in authenticating the user of the user device 145. For example, the relying party 110 may be configured to treat the legacy IDP effectively as another type of authenticator that can be used to authenticate the user of the user device 145 to access certain applications and/or services.

The validity of the authentication confirmation can be confirmed to a relying party (stage 1320). The relying party can be configured to provide the authentication information to the legacy IDP 120 or the authentication server 250 to receive a confirmation whether the confirmation is valid. The FIDO server 115 of the relying party 110 can be configured to validate the authentication confirmation received from the user agent 125 of the user device 145. For example, The FIDO server 115 can validate the digital signature of the OTP and/or other session-specific information and/or the authentication confirmation using the public key associated with the user device 145 that was provided to the FIDO server 115. The legacy IDP 120 can also be configured to associate the OTP and/or other session specific information provided by the user device 145 with the federation credentials. The legacy IDP 120 can provide the OTP and/or other session specific information to the FIDO server 115 of the relying party 110 responsive to the FIDO server 115 sending the federation authentication confirmation received from the user device 145 to the legacy IDP 120. If the OTP and/or other session specific information received from the legacy IDP 120 matches the OTP and/or other session specific information that the FIDO server 115 originally provided to the user device 145, then the relying party 110 can confirm the validity of the authentication confirmation.

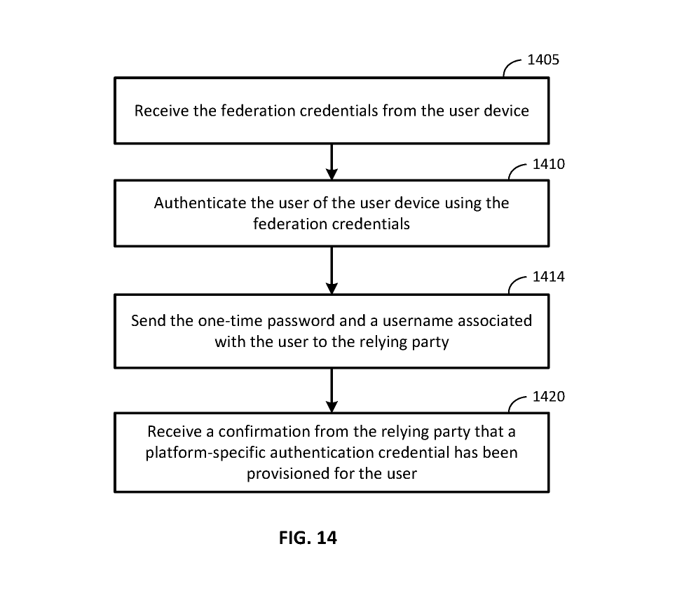

FIG. 14 is a flow diagram of an process for authentication according to the disclosure. The process illustrated in FIG. 14 can be implemented by a legacy identity provider, which can provide the means for performing the various stages of the process of FIG. 14. The legacy identity provider can be similar to legacy IDP 120 of FIG. 1 or the authentication server 250 illustrated in FIG. 2, which can in turn, be implemented by a computing device, such as the example computing device 1500 illustrated in FIG. 15. The process illustrated in FIG. 14 can be used to implement, at least in part, stage 1205 of the process illustrated in FIG. 12. The process illustrated in FIG. 13 can be used to implement, at least in part, the processes illustrated in FIG. 2. The order of the stages of the process can be altered and additional stages can be added and/or one or more of the stages discussed herein may be omitted in some implementations.

Federation credential can be received from a user device (stage 1405). The user device can provide federation credentials, such a username and password or other federation credentials to the legacy IDP 120 or the authentication server 250. The user of the user device can then be authenticated using the federation credentials (stage 1410). The legacy IDP 120 or the authentication server 250 can authenticate the user of the user device using the federation credentials that were provided in stage 1305.

A one-time password and a username associated with the user can be sent to a relying party (stage 1415). The legacy IDP 120 or the authentication server 250 can be configured to generate a one-time password responsive to the user device providing valid federation credentials to the legacy IDP 120 or the authentication server 250. The authentication server send the OTP and a username associated with the user device to the relying party in order to have the relying party generate a platform-specific authentication credential for the user of the user device.

A confirmation can be received from the relying party that a platform-specific authentication credential has been provisioned for the user (stage 1420). The relying party can send a confirmation indicating that the authentication credential has been provision for the user. A response can be sent to the user device indicating that the provisioning of the platform-specific authentication credential was successful. The legacy IDP 120 or the authentication server 250 can generate an HTTP response with a status code of 302, which can include a URI of the relying party 210 and which can redirect the user agent of the user device 245 to the relying party 210. This enables the relying party 210 to associate the authentication credential with the federation credential used by the authentication server 250. This technique allows the relying party to leverage the user onboarding of the legacy IDP (authentication server 250).

FIG. 15 is a functional block diagram of an example computing device 1500 that can be used to implement various devices disclosed herein, such as the user device 145, the user device 245, the relying party 110, the relying party 210, the legacy IDP 120, the RP database 240, and/or the authentication server 250 discussed in the preceding example implementations. For the sake of simplicity, the various features/components/functions illustrated in the schematic boxes of FIG. 15 can be connected together using a common bus or are can be otherwise operatively coupled together. Other connections, mechanisms, features, functions, or the like, may be provided and adapted as necessary to operatively couple and configure a computing device 1500. Furthermore, one or more of the features or functions illustrated in the example of FIG. 15 may be further subdivided, or two or more of the features or functions illustrated in FIG. 15 may be combined. Additionally, one or more of the features or functions illustrated in FIG. 15 may be excluded.

As shown, the computing device 1500 can include a network interface 1505 that can be configured to provide wired and/or wireless network connectivity to the computing device 1500. The network interface can include one or more local area network transceivers that can be connected to one or more antennas (not shown). The one or more local area network transceivers comprise suitable devices, circuits, hardware, and/or software for communicating with and/or detecting signals to/from one or more of the wireless local area network (WLAN) access points, and/or directly with other wireless devices within a network. The network interface 1505 can also include, in some implementations, one or more wide area network transceiver(s) that can be connected to the one or more antennas (not shown). The wide area network transceiver can comprise suitable devices, circuits, hardware, and/or software for communicating with and/or detecting signals from one or more of, for example, the wireless wide area network (WWAN) access points and/or directly with other wireless devices within a network. The network interface 1505 can include a wired network interface instead of or in addition to one or more of the wireless network interfaces discussed above. The network interface 1505 can be used to receive data from and send data to one or more other network-enabled devices via one or more intervening networks.

The processor(s) (also referred to as a controller) 1510 may be connected to the memory 1515, the authentication unit 1570, the user interface 1550, and the network interface 1505. The processor may include one or more microprocessors, microcontrollers, and/or digital signal processors that provide processing functions, as well as other calculation and control functionality. The processor 1510 may be coupled to storage media (e.g., memory) 1515 for storing data and software instructions for executing programmed functionality within the computing device. The memory 1515 may be on-board the processor 210 (e.g., within the same IC package), and/or the memory may be external memory to the processor and functionally coupled over a data bus.

A number of software modules and data tables may reside in memory 1515 and may be utilized by the processor 1510 in order to manage, create, and/or remove content from the computing device 1500 and/or perform device control functionality. As illustrated in FIG. 15, in some embodiments, the memory 1515 may include an application module 1520 which can implement one or more applications. It is to be noted that the functionality of the modules and/or data structures may be combined, separated, and/or be structured in different ways depending upon the implementation of the computing device 1500. The application module 1520 can comprise one or more trusted applications that can be executed by the trusted execution environment 1580 of the computing device 1500.

The application module 1520 may be a process or thread running on the processor 1510 of the computing device 1500, which may request data from one or more other modules (not shown) of the computing device 1500. Applications typically run within an upper layer of the software architectures and may be implemented in a rich execution environment of the computing device 1500, and may include navigation applications, games, shopping applications, content streaming applications, web browsers, location aware service applications, etc.

The processor 1510 may include a trusted execution environment 1580. The trusted execution environment 1580 can be used to implement a secure processing environment for executing secure software applications. The trusted execution environment 1580 can be implemented as a secure area of the processor 1510 that can be used to process and store sensitive data in an environment that is segregated from the rich execution environment in which the operating system and/or applications (such as those of the application module 1520) may be executed. The trusted execution environment 1580 can be configured to execute trusted applications that provide end-to-end security for sensitive data by enforcing confidentiality, integrity, and protection of the sensitive data stored therein. The trusted execution environment 1580 can be used to store encryption keys, authentication information, and/or other sensitive data. The trusted execution environment 1580 can be used to implement one or more authenticators that can be used by the authentication unit 1570 to authenticate a user of the computing device 1500.

The computing device 1500 may further include a user interface 1550 providing suitable interface systems for outputting audio and/visual content, and for facilitating user interaction with the computing device 1500. For example, the user interface 1550 may comprise one or more of a microphone and/or a speaker for outputting audio content and for receiving audio input, a keypad and/or a touchscreen for receiving user inputs, and a display (which may be separate from the touchscreen or be the touchscreen) for displaying visual content.

The authentication unit 1570 can provide the means for performing the various authentication processes recited herein and illustrated in FIGS. 1-14 depending upon the device in which the computing device 1500 has been used to implement. The authentication unit 1570 can be configured to utilize sensor data 1575 from the sensor(s) 1575, which can be included in implementations of the user device 145 or user device 245, to perform authentication on a user of the computing device 1500. The authentication unit 1570 can be implemented in hardware, software, or a combination thereof. The functionality of the authentication unit 1570 can be implemented by hardware components of the trusted execution environment 1580, the processor 1510, or a combination thereof. The functionality of the authentication unit 1570 may also be implemented by processor executable code that is executed by the trusted execution environment 1580 and/or the processor 1510.

The sensor(s) 1575 can comprise one or more sensors that can be used to assist to collect data that can be used to perform authentication. The sensor(s) 1575 can comprise sensors for obtaining biometric information to authenticate a user, such as a fingerprint sensor, an audio sensor for voice analysis, an optical sensor for performing retinal scans or for performing facial recognition, and/or other sensors for identifying other physiological and/or behavioral characteristics that can be used to authenticate a user of the computing device 1500. The sensor(s) 1575 can output sensor data that the authentication unit 1570 can use to authenticate a user. Other types of sensors can also be included in addition to or instead of those discussed above.

In implementations where computing device 1500 is used to implement the relying party 110, the relying party 210, or the RP database 240, the database 1525 can be used to store implement the relying party database and can be used to store the platform-specific authentication credentials for the user device.

Example implementations according to the disclosure include the following.
E1. An example method for authenticating a user comprising:

authenticating the user of a user device with a relying party using an assertion from an authentication entity, wherein the user device and the relying party support platform-specific authentication and the authentication entity does not support platform-specific authentication; and

providing access to an application or service provided by the relying party responsive to authenticating the user of the user device with both the relying party and the authentication entity.
E2. The example of claim E1, wherein the authentication entity is a legacy identity provider configured to provide federation authentication.
E3. The example of claim E2, wherein authenticating the user of the user device with the relying party using the assertion from the authentication entity further comprises:

receiving a platform-specific authentication credential from the user device;

generating a one-time password;

sending the one-time password to the user device;

receiving an authentication confirmation from the user device, the authentication having been generated by the legacy identity provider; and

authenticating the user device with the relying party.
E4. The example of claim E3, wherein authenticating the user device with the relying party further comprises:

sending an authentication challenge to the user device; and

receiving an authentication assertion from the user device.
E5. The example of claim E1, wherein the authentication entity is an authentication server, and wherein authenticating the user of the user device with the relying party using the assertion from the authentication entity:

receiving, at the, relying party, a request for provisioning of a platform-specific authentication credential for the user device;

generating a one-time password;

providing the one-time password to the user device;

directing the user device to provide federation credentials and the one-time password to the authentication server;

receiving a username and the one-time password from the authentication server responsive to the authentication server authenticating the federation credentials;

provisioning the platform-specific authentication credential for the user device.
E6. The example of claim E5, further comprising:

storing the platform-specific authentication credential for the user device in a relying party database.
E7. The example of claim E5, further comprising:

sending a confirmation to the authentication server that the platform-specific authentication credential has been provisioned.
E8. An apparatus comprising:

a processor configured to:
authenticate a user of a user device with a relying party using an assertion from an authentication entity, wherein the user device and the relying party support platform-specific authentication and the authentication entity does not support platform-specific authentication; and
provide access to an application or service provided by the relying party responsive to authenticating the user of the user device with both the relying party and the authentication entity.
E9. An apparatus comprising:

means for authenticating a user of a user device with a relying party using an assertion from an authentication entity, wherein the user device and the relying party support platform-specific authentication and the authentication entity does not support platform-specific authentication; and

means for providing access to an application or service provided by the relying party responsive to authenticating the user of the user device with both the relying party and the authentication entity.
E10. A non-transitory, computer-readable medium, having stored thereon computer-readable instructions for authenticating a user of a user device, comprising instructions configured to cause a computing device to:

authenticate the user of the user device with a relying party using an assertion from an authentication entity, wherein the user device and the relying party support platform-specific authentication and the authentication entity does not support platform-specific authentication; and

provide access to an application or service provided by the relying party responsive to authenticating the user of the user device with both the relying party and the authentication entity.
E11. A method for authenticating a user by a authentication entity comprising:

authenticating the user of a user device using federation credentials; and

confirming authentication of the user of the user device to a relying party, wherein the user device and the relying party support platform-specific authentication and the authentication entity does not support platform-specific authentication.
E12. The method of claim E11, wherein the authentication entity is a legacy identity provider configured to provide federation authentication, and wherein authenticating the user of the user device using the federation credentials further comprises:

receiving the federation credentials from the user device;

authenticating the user of the user device using the federation credentials;

providing an authentication confirmation to the user device; and

confirming the validity of the authentication confirmation to the relying party.
E13. The method of claim E11, wherein the authentication entity is a authentication server, and wherein authenticating the user of the user device using the federation credentials further comprises:

receiving the federation credentials and a one-time password from the user device;

authenticating the user of the user device using the federation credentials; and

responsive to authenticating the user of the user device,
sending the one-time password and a username associated with the user to the relying party, and
receiving a confirmation from the relying party that a platform-specific authentication credential has been provisioned for the user.
E14. An apparatus comprising:

a processor configured to:
authenticate a user of a user device using federation credentials; and
confirm authentication of the user of the user device to a relying party, wherein the user device and the relying party support platform-specific authentication and the authentication entity does not support platform-specific authentication.
E15. An apparatus comprising:

means for authenticating a user of a user device using federation credentials; and

means for confirming authentication of the user of the user device to a relying party, wherein the user device and the relying party support platform-specific authentication and the authentication entity does not support platform-specific authentication.
E16. A non-transitory, computer-readable medium, having stored thereon computer-readable instructions for authenticating a user of a user device, comprising instructions configured to cause a computing device to:

authenticate a user of a user device using federation credentials; and confirm authentication of the user of the user device to a relying party, wherein the user device and the relying party support platform-specific authentication and the authentication entity does not support platform-specific authentication.
E17. A user device comprising:

means for authenticating a user of a user device with a relying party and an authentication entity, wherein the user device and the relying party support platform-specific authentication and the authentication entity does not support platform-specific authentication; and

means for accessing an application or service provided by the relying party responsive to authenticating the user of the user device with both the relying party and the authentication entity.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Memory may be implemented within the computing-based device or external to the device. As used herein the term “memory” refers to any type of long term, short term, volatile, nonvolatile, or other memory and is not to be limited to any particular type of memory or number of memories, or type of media upon which memory is stored.

If implemented in-part by hardware or firmware along with software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

As used herein, a mobile device or station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” (or “mobile device” or “wireless device”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, tablet devices, etc., which are capable of communication with a server, such as via the Internet, WiFi, or other network, and to communicate with one or more types of nodes, regardless of whether satellite signal reception, assistance data reception, and/or position-related processing occurs at the device, at a server, or at another device or node associated with the network. Any operable combination of the above are also considered a “mobile station.” A mobile device may also be referred to as a mobile terminal, a terminal, a user equipment (UE), a device, a Secure User Plane Location Enabled Terminal (SET), a target device, a target, or by some other name.

While some of the techniques, processes, and/or implementations presented herein may comply with all or part of one or more standards, such techniques, processes, and/or implementations may not, in some embodiments, comply with part or all of such one or more standards.

What is claimed:

1. A method for authenticating a user comprising:
authenticating the user of a user device with a relying party and an authentication entity, wherein the user device and the relying party support platform-specific authentication and the authentication entity does not support platform-specific authentication; and
accessing an application or service provided by the relying party responsive to authenticating the user of the user device with both the relying party and the authentication entity.

2. The method of claim 1, wherein the authentication entity is a legacy identity provider configured to provide federation authentication.

3. The method of claim 2, wherein authenticating the user of the user device with a relying party and the authentication entity further comprises:
creating a platform-specific authentication credential;
sending the platform-specific authentication credential to the relying party;
receiving a one-time password from the relying party;
sending the one-time password and federation credentials to the legacy identity provider;
receiving an authentication confirmation from the legacy identity provider;
providing the authentication confirmation to the relying party; and
authenticating the user device with the relying party.

4. The method of claim 3, wherein authenticating the user device with the relying party further comprises:
receiving an authentication challenge from the relying party;
performing an authentication to generate a platform-specific authentication assertion; and
providing the platform-specific authentication assertion to the relying party.

5. The method of claim 1, wherein the authentication entity is an authentication server, and wherein authenticating the user of the user device with a relying party and the authentication entity further comprises:
requesting, at the user device, provisioning of a platform-specific authentication credential from the relying party; and
receiving a one-time password from the relying party.

6. The method of claim 5, the method of claim 5 further comprising:
providing the one-time password and federation credentials to the authentication server to establish the platform-specific authentication credential associated with the federation credentials.

7. The method of claim 6, further comprising:
receiving the platform-specific authentication credential from the authentication server.

8. A user device comprising:
a processor configured to:
authenticate a user of the user device with a relying party and an authentication entity, wherein the user device and the relying party support platform-specific authentication and the authentication entity does not support platform-specific authentication; and
access an application or service provided by the relying party responsive to authenticating the user of the user device with both the relying party and the authentication entity.

9. The user device of claim 8, wherein the authentication entity is a legacy identity provider configured to provide federation authentication.

10. The user device of claim 9, wherein the processor being configured to authenticate the user of the user device with a relying party and the authentication entity is further configured to:
create a platform-specific authentication credential;
send the platform-specific authentication credential to the relying party;
receive a one-time password from the relying party;
send the one-time password and federation credentials to the legacy identity provider;
receive an authentication confirmation from the legacy identity provider;
provide the authentication confirmation to the relying party; and
authenticate the user device with the relying party.

11. The user device of claim 10, wherein the processor being configured to authenticate the user device with the relying party is further configured to:
receive an authentication challenge from the relying party;
perform an authentication to generate a platform-specific authentication assertion; and
provide the platform-specific authentication assertion to the relying party.

12. The user device of claim 8, wherein the authentication entity is an authentication server, and wherein the processor being configured to authenticate the user of the user device with a relying party and the authentication entity is further configured to:
request, at the user device, provisioning of a platform-specific authentication credential from the relying party; and
receive a one-time password from the relying party.

13. The user device of claim 12, wherein the processor is further configured to:
provide the one-time password and federation credentials to the authentication server to establish the platform-specific authentication credential associated with the federation credentials.

14. The user device of claim 13, wherein the processor is further configured to:
receive the platform-specific authentication credential from the authentication server.

15. A non-transitory, computer-readable medium, having stored thereon computer-readable instructions for authenticating a user of a user device, comprising instructions configured to cause a computing device to:
authenticate the user of the user device with a relying party and an authentication entity, wherein the user device and the relying party support platform-specific authentication and the authentication entity does not support platform-specific authentication; and
access an application or service provided by the relying party responsive to authenticating the user of the user device with both the relying party and the authentication entity.

16. The non-transitory, computer-readable medium of claim 15, wherein the authentication entity is a legacy identity provider configured to provide federation authentication, and wherein the instructions configured to cause the computing device to authenticate the user of the user device with a relying party and the authentication entity further comprise instructions configured to cause the computing device to:
create a platform-specific authentication credential;
send the platform-specific authentication credential to the relying party;
receive a one-time password from the relying party;
send the one-time password and federation credentials to the legacy identity provider;
receive an authentication confirmation from the legacy identity provider;
provide the authentication confirmation to the relying party; and
authenticate the user device with the relying party.

17. The non-transitory, computer-readable medium of claim 16, wherein the instructions configured to cause the computing device to authenticate the user device with the relying party further comprise instructions configured to cause the computing device to:
receive an authentication challenge from the relying party;
perform an authentication to generate a platform-specific authentication assertion; and
provide the platform-specific authentication assertion to the relying party.

18. The non-transitory, computer-readable medium of claim 15, wherein the authentication entity is an authentication server, and wherein the instructions configured to cause the computing device to authenticate the user of the user device with a relying party and the authentication entity further comprise instructions configured to cause the computing device to:
request, at the user device, provisioning of a platform-specific authentication credential from the relying party; and
receive a one-time password from the relying party.

19. The non-transitory, computer-readable medium of claim 18, further comprising instructions configured to cause the computing device to:
provide the one-time password and federation credentials to the authentication server to establish the platform-specific authentication credential associated with the federation credentials.

20. The non-transitory, computer-readable medium of claim 19, further comprising instructions configured to cause the computing device to:
receive the platform-specific authentication credential from the authentication server.
